(19) United States
(12) Patent Application Publication
(10) Pub. No.: US 2020/0411980 A1
(43) Pub. Date: Dec. 31, 2020

(54) PATCH ANTENNA AND RADAR APPARATUS HAVING DIFFERENT BEAM TILTS WITH RESPECT TO FREQUENCIES

(71) Applicant: SMART RADAR SYSTEM, INC., Seongnam-si (KR)

(72) Inventors: Yong Jae Kim, Yongin-si (KR); Jae Yong Lee, Anyang-si (KR); Kyoung Sub Oh, Hwaseong-si (KR)

(73) Assignee: SMART RADAR SYSTEM, INC., Seongnam-si (KR)

(21) Appl. No.: 16/455,770

(22) Filed: Jun. 28, 2019

(51) Int. Cl. H01Q 3/22; H01Q 9/04; H01Q 21/08; G01S 7/03

(52) U.S. Cl. CPC H01Q 3/22; G01S 7/032; H01Q 21/08; H01Q 9/0407

(57) ABSTRACT

A patch antenna and a radar apparatus having different beam tilts with respect to frequencies are provided. In the patch antenna including a plurality of patches arranged along a power feed line, lengths of patches relating to a resonant frequency are implemented to be different from distances between patches relating to a radiation angle in the elevation direction without mechanical tilting. Thus, the patch antenna can easily expand coverage in the elevation direction without raising a noise floor, and since a gain is high, the patch antenna can detect a smaller object.

### BACKGROUND

### 1. Field

The following description relates to a patch antenna, and more particularly, to a patch antenna and a radar apparatus having different beam tilts with respect to frequencies.

### 2. Description of Related Art

When an installation position of a radar is higher than a detection position thereof, digital beamforming is performed in an azimuth direction so that the radar can have wide coverage. However, since the radar has a fixed beam width in an elevation direction, the radar is mechanically tilted to detect only an area which is covered by a beam.

In such a mechanical tilting method, it is necessary for the radar to be more tilted so as to detect a position adjacent thereto. As shown in FIG. 1, a signal reflected from a floor which is proportional according to cos²φ increases such that a noise floor increases. The noise floor is also called “floor noise” and means minimum noise power.

In order to have a wide coverage area without mechanical tilting, the radar can use a wide beam width. However, when a beam width increases, an antenna gain decreases.

Meanwhile, in order to lower a noise floor, a technique for electrically tilting a radar without mechanical tilting has been proposed. In an electric tilting method, a main component in an electric (E) field direction of a radiated beam is perpendicular to a floor such that the noise floor is formed to be low.

Korean Registered Patent No. 10-1195778 (Issued Date: Oct. 24, 2012) discloses a technique for electrically adjusting a tilt (a variation in elevation angle of a main beam of an antenna) for controlling a coverage area of the antenna by varying a signal phase or a time delay of an antenna array element without physical movement.

Inventors of the present invention have studied a patch antenna and a radar apparatus having different beam tilts with respect to frequencies. In the patch antenna including a plurality of patches arranged along a power feed line, lengths of patches relating to a resonant frequency of the patch antenna are implemented to be different from distances between patches relating to a radiated angle in an elevation direction, thereby differentiating beam tilts with respect to frequencies.

### RELATED ART DOCUMENT

### Patent Document

(Patent Document 1) Korean Registered Patent No. 10-1195778 (Oct. 24, 2012)

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a patch antenna and a radar apparatus having different beam tilts with respect to frequencies, which are configured such that, in the patch antenna including a plurality of patches arranged along a power feed line, lengths of the patches relating to a resonant frequency are implemented to be different from distances between the patches relating to a radiated angle in an elevation direction, thereby differentiating beam tilts with respect to frequencies.

In one general aspect, a patch antenna having different beam tilts with respect to frequencies includes a power feed line and a plurality of patches arranged along the power feed line, wherein lengths of the patches relating to a resonant frequency are different from each other, and distances between the patches relating to a radiation angle in an elevation direction are different from each other.

In another general aspect, a radar apparatus having different beam tilts with respect to frequencies includes at least one transmitting antenna and at least one receiving antenna, wherein the at least one transmitting antenna or the at least one receiving antenna includes a power feed line and a plurality of patches arranged along the power feed line, lengths of the patches relating to a resonant frequency are different from each other, and distances between the patches relating to a radiation angle in an elevation direction are different from each other.

According to an additional aspect of the present invention, as patches are arranged to be closer to the ground, the lengths of the patches may increase to radiate signals at a lower resonant frequency.

According to an additional aspect of the present invention, as patches are arranged to be closer to the ground, the distances between the patches may decrease such that the radiation angle in the elevation direction is directed more toward the ground.

According to an additional aspect of the present invention, the lengths of the patches and the distances therebetween may be provided to be random regardless of arrangement positions of the patches.

According to an additional aspect of the present invention, widths of the patches relating to signal radiation power may be different from each other.

Other features and aspects will be apparent from the following detailed description, the drawings, and the claims.

### BRIEF DESCRIPTION OF THE DRAWINGS

FIG. 1 is a diagram illustrating a mechanically tilted radar.

FIG. 2 is a diagram illustrating a configuration of a patch antenna having different beam tilts with respect to frequencies according to one embodiment of the present invention.

FIG. 3A, 3B show graphs for comparing a conventional beam pattern with a beam pattern in an elevation direction of the patch antenna having different beam tilts with respect to frequencies according to the present invention.

FIG. 4A, 4B show graphs illustrating a reflection coefficient and a voltage standing wave ratio (VSWR) characteristic of the patch antenna having different beam tilts with respect to frequencies according to the present invention.

FIG. 5 is a diagram illustrating a configuration of a radar apparatus having different beam tilts with respect to frequencies according to one embodiment of the present invention.

FIG. 6 is a diagram showing transmitted and received waveforms of a frequency modulated continuous wave (FMCW).

FIG. 7 is a diagram illustrating a beam tilt of the radar apparatus having different beam tilts with respect to frequencies according to the present invention.

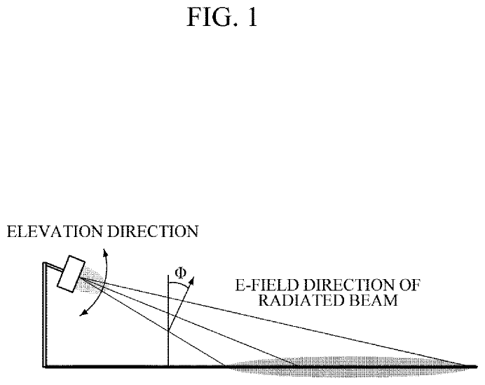

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, a description will be made in detail of exemplary embodiments of the present invention with reference to the accompanying drawings so as to allow a person skilled in the art to easily understand and practice the present invention. While specific embodiments have been illustrated in the accompanying drawings and described in this disclosure, it is not intended to limit various embodiments of the present invention to a specific form.

In the following description of the present invention, if a detailed description of related known configurations or functions is determined to unnecessarily obscure the gist of embodiments of the present invention, a detailed description thereof will be omitted.

When a component is referred to as being “connected,” or “coupled” to another component, it may be directly connected or coupled to another component, but it should be understood that yet another component may be present therebetween.

On the contrary, when a component is referred to as being “directly connected” or “directly coupled” to another component, it should be understood that yet another component may be absent between the component and another component.

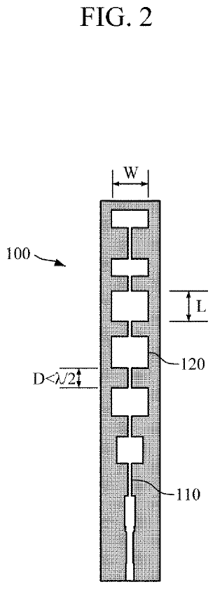

FIG. 2 is a diagram illustrating a configuration of a patch antenna having different beam tilts with respect to frequencies according to one embodiment of the present invention. As shown in FIG. 2, a patch antenna 100 having different beam tilts with respect to frequencies according to the present embodiment includes a power feed line 110 and a plurality of patches 120 arranged along the power feed line 110.

In this case, in order to differentiate beam tilts with respect to frequencies, lengths L of patches 120 relating to a resonant frequency are implemented to be different from each other, and distances D between patches 120 relating to a radiation angle in an elevation direction are implemented to be different from each other.

The patch antenna 100 has a characteristic in which, as the lengths L of the patches 120 decrease, a resonant frequency increases, while as the lengths L of the patches 120 increase, the resonant frequency decreases. Consequently, when the lengths L of the patches 120 relating to a resonant frequency are implemented to be different from each other, beamforming for each frequency may be possible.

Further, the patch antenna 100 has a characteristic in which, as the distances D between the patches 120 decrease, a beam radiation direction in the elevation direction is more toward the ground such that a beam radiation angle increases, whereas as the distances D between the patches 120 increase, the beam radiation direction in the elevation direction is less toward the ground such that the beam radiation angle decreases. Consequently, when the distances D between the patches 120 relating to a radiated angle in the elevation direction are implemented to be different from each other, it is possible to adjust beam tilt directions of the patches 120.

In this case, when the distance D between the patches 120 exceeds a half wavelength λ/2, since a radiation direction is directed upward further than a front direction, it is preferable to limit the distance D between the patches 120 to less than or equal to the half wavelength λ/2. This is because coverage of an antenna applied to a radar apparatus for security or a vehicle is directed to a direction toward the ground.

The patch antenna 100 having different beam tilts with respect to frequencies according to the present invention only has to have a coverage area from the direction of the ground to the front direction and differentiate beamformings with respect to resonant frequencies. Thus, there is no need to arrange the lengths L of the patches 120 and the distances D therebetween according to a specific rule.

For example, since lengths of patches arranged to be closer to the ground increase, the patches may be implemented to radiate signals at a lower resonant frequency.

Meanwhile, since distances between the patches arranged to be closer to the ground decrease, the patches may be implemented to direct radiation angles in the elevation direction more toward the ground.

Alternatively, the lengths of the patches and the distances therebetween may be implemented to be random regardless of arrangement positions of the patches.

Meanwhile, according to an additional aspect of the invention, widths W of patches 120 relating to signal radiation power may be implemented to be different from each other. As the widths W of the patches 120 of the patch antenna 100 decrease more, the signal radiation power increases, while as the widths W of the patches 120 of the patch antenna 100 increase more, the signal radiation power decreases.

Since the signal radiation power relates to a radar beam signal detection distance, the widths W of the patches 120 relating to the signal radiation power are implemented to be different from each other such that radar beam signal detection distances for the patches 120 may be adjusted to be different from each other.

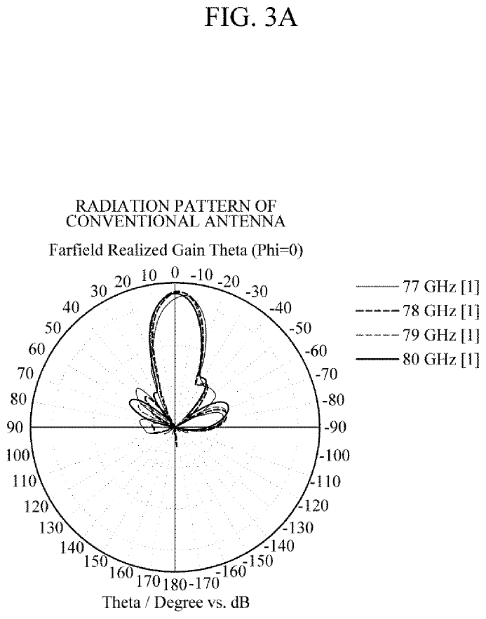

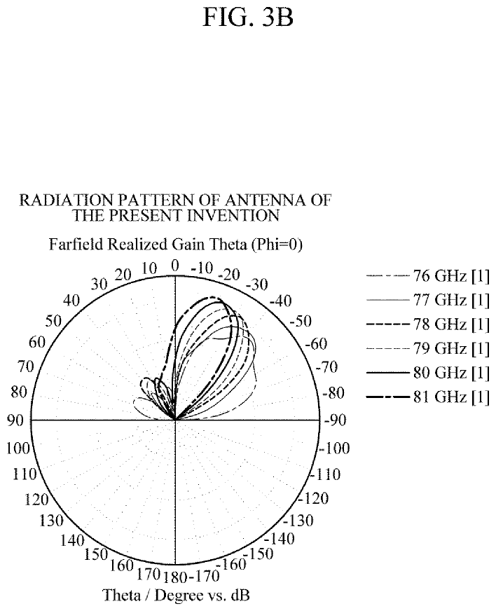

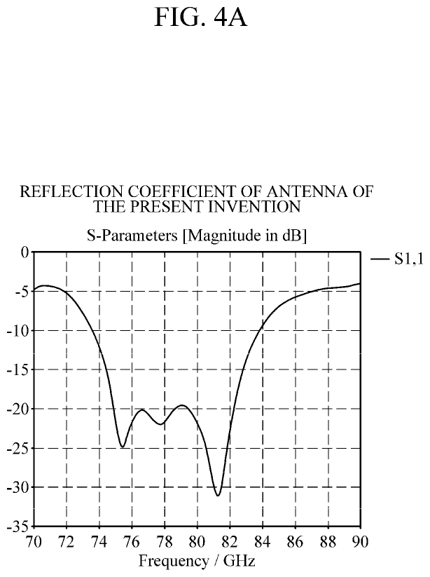

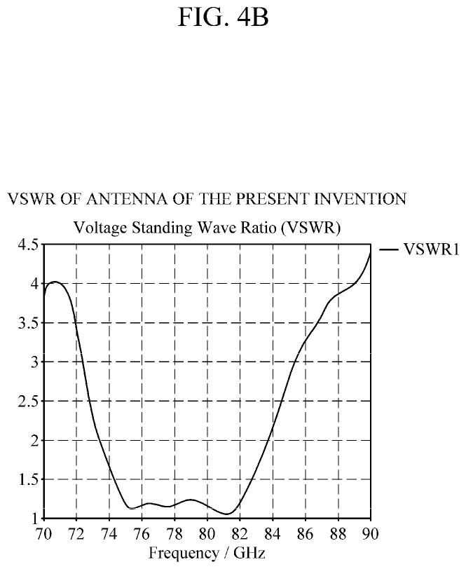

FIG. 3A, 3B show graphs for comparing a conventional beam pattern with a beam pattern in an elevation direction of the patch antenna having different beam tilts with respect to frequencies according to the present invention, and FIG. 4A, 4B show graphs illustrating a reflection coefficient and a voltage standing wave ratio (VSWR) characteristic of the patch antenna having different beam tilts with respect to frequencies according to the present invention.

As shown in the drawings, unlike the conventional patch antenna having narrow coverage, it can be seen that the patch antenna 100 having different beam tilts with respect to frequencies according to the present invention forms beamforming by tilting beams with respect to frequencies, thereby having wide coverage in the elevation direction.

That is, the patch antenna 100 having different beam tilts with respect to frequencies according to the present invention has narrow beamforming areas with respect to frequencies, thereby having a high antenna gain. The beamforming areas having a high gain with respect to frequencies overlap each other to form wide coverage in the elevation direction.

Consequently, in a patch antenna including a plurality of patches arranged along a power feed line according to the present invention, lengths of patches relating to a resonant frequency are implemented to be different from distances between patches relating to a radiation angle in the elevation direction without mechanical tilting. Thus, the patch antenna can easily expand coverage in the elevation direction without raising a noise floor, and since a gain is high, the patch antenna can detect a smaller object.

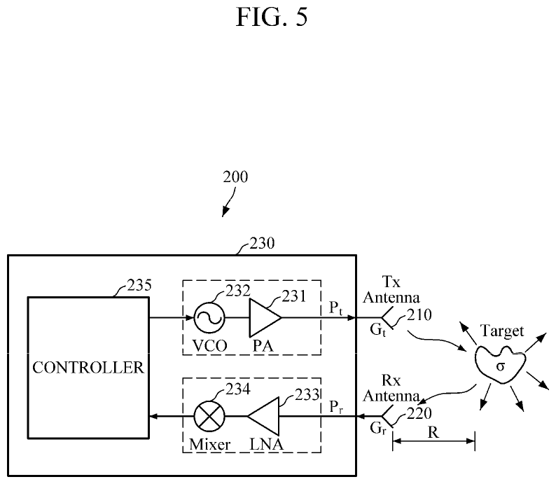

FIG. 5 is a diagram illustrating a configuration of a radar apparatus having different beam tilts with respect to frequencies according to one embodiment of the present invention. As shown in FIG. 5, a radar apparatus 200 having different beam tilts with respect to frequencies according to the present embodiment includes at least one transmitting antenna 210, at least one receiving antenna 220, and a radar chip 230.

Each of the at least one transmitting antenna 210 and the at least one receiving antenna 220 includes a power feed line and a plurality of patches arranged along the power feed line. In this case, a plurality of transmitting antennas 210 or a plurality of receiving antennas 220 may be arranged in parallel in a branch structure.

The radar chip 230 includes a transmitting module having a power amplifier (PA) 231 configured to amplify a frequency signal which is output to the transmitting antenna 210 and a frequency multiplier 232 configured to output power of an output frequency that is n (integer) times an input frequency to the PA 231.

Further, the radar chip 230 includes a receiving module having a low noise amplifier (LNA) 233 configured to perform low-noise amplification on a weak frequency signal input from the receiving antenna 220 and a mixer 234 configured to perform a frequency shift according to the product of a frequency signal output to the transmitting antenna 210 by a frequency signal received from the receiving antenna 220.

Meanwhile, the radar chip 230 includes a controller 235 configured to control transmission and reception of frequency signals, detect an object by analyzing a frequency shift between a frequency signal output through the transmitting module and a frequency signal received through the receiving module, and calculate a distance to the object.

For example, the controller 235 may be implemented to detect the object and calculate a distance to the object using a frequency modulated continuous wave (FMCW).

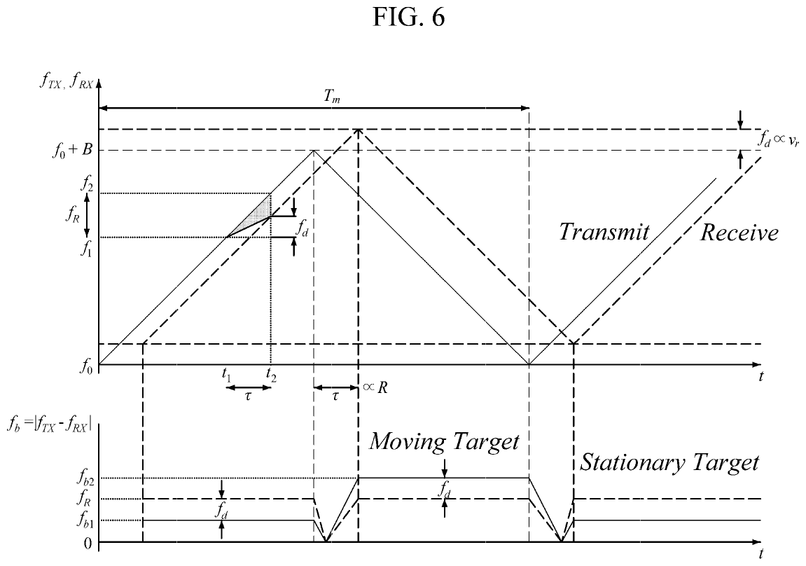

FIG. 6 is a diagram showing transmitted and received waveforms of an FMCW. A transmitted signal f_{TX} sweeps with a bandwidth B corresponding to f₀+B at a bandwidth frequency f₀ for a period of time Tₘ. In FIG. 6, after a time delay of τ=2R/C, a signal f₁ transmitted at time t₁ is observed as having a frequency shift of f_{d} at time t₂, and a signal transmitted at time t₂ has a frequency of f₂.

The mixer 234 detects a bit frequency f_{b} which is a difference between the transmitted signal f_{TX} and a received signal f_{RX} as in the following Equation 1.

$$\begin{matrix}{f}_{b} = \vert {f}_{TX} - {f}_{R X} \vert & [ Equation 1 ] \\ R = \frac{{T}_{m} \cdot c \cdot {F}_{b , stationary}}{4 B} & [ Equation 2 ]\end{matrix}$$

The controller 235 may use Equation 2 to simply calculate a distance to a stationary target object using the bit frequency f_{b}. Since a center frequency of the received signal is shifted due to the Doppler effect when a target object is moving, two bit frequencies may be generated by the mixer 234 as in Equations 3 and 4 according to whether a transmitted signal at a predetermined time is present at an ascending slope or a descending slope of a triangle wave.

f_{b1}=f_{R}−f_{d} [Equation 3]

f_{b2}=f_{R}+f_{d} [Equation 4]

A distance to the moving target object and a relative speed with respect thereto may be calculated by Equations 5 and 6 using the bit frequencies calculated by Equations 3 and 4.

$$\begin{matrix}R = \frac{c ( {f}_{b 1} + {f}_{b 2} ) {T}_{m}}{8 B} & [ Equation 5 ] \\ {V}_{r} = \frac{c ( {f}_{b 1} - {f}_{b 2} )}{4 {f}_{0}} & [ Equation 6 ]\end{matrix}$$

Here, a variable f₀ means a frequency of the transmitted signal. An intermediate frequency (IF) signal of the bit frequency f_{b}, which is generated by the mixer 234, is a square wave having a period of Tₘ/2. When the IF signal is Fourier transformed and expressed in a frequency domain, the IF signal is expressed as a sinc function having a center frequency of f_{b}.

In this case, an initial zero crossing point exhibits at 2/Tₘ, and a reciprocal value of the initial zero crossing point becomes a minimum modulation frequency and may be expressed by the Equation 7. Further, when detection resolution of the relative speed is calculated using Equation 7, the detection resolution may be expressed by Equation 8.

$$\begin{matrix}Δ f = \frac{2}{{T}_{m}} & [ Equation 7 ] \\ Δ {V}_{r} = \frac{c}{2 {f}_{0}} \cdot Δ f = \frac{c}{{f}_{0}} \cdot \frac{1}{{T}_{m}} & [ Equation 8 ] \\ Δ R = \frac{c \cdot {T}_{m}}{4 B} \cdot Δ f = \frac{c}{2 B} & [ Equation 9 ]\end{matrix}$$

It can be seen from Equation 8 that, as a value of Tm increases or a value of the minimum modulation frequency Δf decreases, the relative speed may be detected with higher resolution. Further, Equation 9 represents distance detection resolution, and it can be seen that, as the bandwidth B increases, distance detection is possible with higher resolution.

As shown in FIG. 2, the transmitting antenna 210 or the receiving antenna 220 of the radar apparatus 200 having different beam tilts with respect to frequencies according to the present invention may be the patch antenna 100 having different beam tilts with respect to frequencies.

In order to differentiate beam tilts with respect to frequencies, the patch antenna 100 having different beam tilts with respect to frequencies is configured such that the lengths L of patches 120 relating to a resonant frequency are implemented to be different from each other, and the distances D between patches 120 relating to a radiated angle in an elevation direction are implemented to be different from each other.

The patch antenna 100 has a characteristic in which, as the lengths L of the patches 120 decrease, a resonant frequency increases, while as the lengths L of the patches 120 increase, the resonant frequency decreases. Consequently, when the lengths L of the patches 120 relating to a resonant frequency are implemented to be different from each other, beamforming for each frequency may be possible.

Further, the patch antenna 100 has a characteristic in which, as the distances D between the patches 120 decrease, a beam radiation direction in the elevation direction is more toward the ground such that a beam radiation angle increases, whereas as the distances D between the patches 120 increase, the beam radiation direction in the elevation direction is less toward the ground such that the beam radiation angle decreases. Consequently, when the distances D between the patches 120 relating to a radiated angle in the elevation direction are implemented to be different from each other, it is possible to adjust beam tilt directions of the patches 120.

In this case, when the distance D between the patches 120 exceeds a half wavelength λ/2, since a radiation direction is directed upward further than the front direction, it is preferable to limit the distance D between the patches 120 to less than or equal to the half wavelength λ/2. This is because coverage of an antenna applied to a radar apparatus for security or a vehicle faces a direction of the ground.

The patch antenna 100 having different beam tilts with respect to frequencies according to the present invention has only to have a coverage area from the direction of the ground to a front direction and differentiate beamformings with respect to resonant frequencies. Thus, there is no need to arrange the lengths L of the patches 120 and the distances D therebetween according to a specific rule.

For example, since lengths of patches arranged to be closer to the ground increase, the patches may be implemented to radiate a signal at a lower resonant frequency.

Meanwhile, since distances between the patches arranged to be closer to the ground decrease, the patches may be implemented to direct radiation angles in the elevation direction more toward the ground.

Alternatively, the lengths of the patches and the distances therebetween may be implemented to be random regardless of arrangement positions of the patches.

Meanwhile, according to an additional aspect of the invention, widths W of patches 120 relating to signal radiation power may be implemented to be different from each other. As the widths W of the patches 120 of the patch antenna 100 decrease more, the signal radiation power increases, while as the widths W of the patches 120 of the patch antenna 100 increase more, the signal radiation power decreases.

Since the signal radiation power relates to a radar beam signal detection distance, the widths W of the patches 120 relating to the signal radiation power are implemented to be different from each other such that radar beam signal detection distances for the patches 120 may be adjusted to be different from each other.

As shown in FIGS. 3 and 4, unlike the conventional patch antenna having narrow coverage, it can be seen that the patch antenna 100 having different beam tilts with respect to frequencies according to the present invention performs beamforming by tilting beams with respect to frequencies, thereby having wide coverage in the elevation direction.

That is, the patch antenna 100 having different beam tilts with respect to frequencies has narrow beamforming areas with respect to frequencies, thereby having a high antenna gain. The beamforming areas having a high gain with respect to frequencies overlap each other to form wide coverage in the elevation direction.

Consequently, in a patch antenna including a plurality of patches arranged along a power feed line according to the present invention, lengths of patches relating to a resonant frequency are implemented to be different from distances between patches relating to a radiation angle in the elevation direction without mechanical tilting. Thus, the patch antenna can easily expand coverage in the elevation direction without raising a noise floor, and since a gain is high, the patch antenna can detect a smaller object.

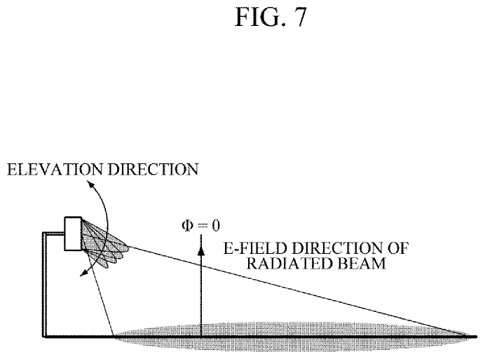

FIG. 7 is a diagram illustrating a beam tilt of the radar apparatus having different beam tilts with respect to frequencies according to the present invention. As shown in FIG. 7, in the radar apparatus having different beam tilts with respect to frequencies according to the present invention, it can be seen that different beamforming areas with respect to frequencies overlap each other without mechanical tilting, thereby forming wide coverage in the elevation direction.

At least a portion of an apparatus (for example, modules or functions thereof) or a method (for example, operations) according to the various embodiments of the present invention may be implemented with instructions stored in a computer-readable storage medium in a form of a programming module.

When the instructions are executed by one or more processors, the one or more processors may perform functions corresponding to the instructions. At least a portion of the programming module stored in the computer-readable storage medium may be implemented (e.g., executed) by, for example, a processor. The at least a portion of the programming module may include, for example, modules, programs, routines, sets of instructions, or processes for performing one or more functions.

In accordance with the present invention, in a patch antenna including a plurality of patches arranged along a power feed line according to the present invention, lengths of patches relating to a resonant frequency are implemented to be different from distances between patches relating to a radiation angle in the elevation direction without mechanical tilting. Thus, there is an effect in that the patch antenna can easily expand coverage in the elevation direction without raising a noise floor, and since a gain is high, the patch antenna can detect a smaller object.

It should be understood that the various embodiments disclosed in the disclosure and the drawings are only illustrative of specific examples for purposes of facilitating understanding and are not intended to limit the scope of the various embodiments of the present disclosure.

Therefore, it should be construed that, in addition to the embodiments described herein, all of alternations and modifications derived from the technical spirit of the various embodiments of the present invention will fall within the scope of the various embodiments of the present invention.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A patch antenna having different beam tilts with respect to frequencies, comprising:
a feed line; and
a plurality of patches arranged along the feed line,
wherein lengths of the patches relating to a resonant frequency are different from each other, and
distances between the patches relating to a radiation angle in an elevation direction are different from each other.

2. The patch antenna of claim 1, wherein, as the patches are arranged to be closer to the ground, the lengths of the patches increase to radiate signals at a lower resonant frequency.

3. The patch antenna of claim 1, wherein, as the patches are arranged to be closer to the ground, the distances between the patches decrease such that the radiation angle in the elevation direction is directed more toward a direction of the ground.

4. The patch antenna of claim 1, wherein the lengths of the patches and the distances therebetween are provided to be random regardless of arrangement positions of the patches.

5. The patch antenna of any one of claim 1, wherein widths of the patches relating to signal radiation power are different from each other.

6. A radar apparatus having different beam tilts with respect to frequencies, comprising:
at least one transmitting antenna; and
at least one receiving antenna,
wherein the at least one transmitting antenna or the at least one receiving antenna includes:
a feed line; and
a plurality of patches arranged along the power feed line,
wherein lengths of the patches relating to a resonant frequency are different from each other, and
distances between the patches relating to a radiation angle in an elevation direction are different from each other.

7. The radar apparatus of claim 6, wherein, as the patches are arranged to be closer to the ground, the lengths of the patches increase to radiate signals at a lower resonant frequency.

8. The radar apparatus of claim 6, wherein, as the patches are arranged to be closer to the ground, the distances between the patches decrease such that the radiation angle in the elevation direction is directed more toward a direction of the ground.

9. The radar apparatus of claim 6, wherein the lengths of the patches and the distances therebetween are provided to be random regardless of arrangement positions of the patches.

10. The radar apparatus of any one of claim 6, wherein widths of the patches relating to signal radiation power are different from each other.
